(19) United States
(12) Patent Application Publication
(10) Pub. No.: US 2026/0103178 A1
(43) Pub. Date: Apr. 16, 2026

(54) Vehicle Brake Disc Temperature Monitoring Method and Apparatus

(71) Applicant: Robert Bosch GmbH, Stuttgart (DE)

(72) Inventors: Jinyang Li, Suzhou (CN); Xinhua Liu, Shanghai (CN); Bin Deng, Suzhou (CN); Zhong Xu, Suzhou (CN); Longguang Xiong, Suzhou (CN)

(21) Appl. No.: 19/357,435

(22) Filed: Oct. 14, 2025

(30) Foreign Application Priority Data
Oct. 15, 2024 (CN) 2024 1144 0756.8

(51) Int. Cl. B60T 17/22; B60T 8/171; B60T 8/172; F16D 66/00; G01K 1/14; G01K 3/00; G01K 7/02; G01K 7/22

(52) U.S. Cl. CPC B60T 17/22; B60T 8/171; B60T 8/172; F16D 66/00; G01K 1/14; G01K 3/005; G01K 7/02; G01K 7/22; B60T 2210/30; F16D 2066/001

(57) ABSTRACT

A vehicle brake disc temperature monitoring unit includes (i) a temperature collection module, which collects temperature values near the brake disc that change over time during vehicle braking, (ii) a temperature estimation module, which uses an observation model and a state estimation model to estimate the temperature of the brake disc based on the temperature values collected by the temperature collection module and the estimated values of the actual temperature of the brake disc through the Kalman filtering process, and (iii) a control module, which adjusts and controls the braking state of the vehicle braking system through the estimated temperature values and the detection values of the temperature sensor. In view of the above, it is possible to use a temperature sensor that is not in contact with the brake disc and utilize the Kalman filtering method to effectively estimate the temperature of the brake disc when it is impossible to directly measure the temperature of the brake disc using the temperature sensor installed on or abutting the brake disc, improving monitoring accuracy and allowing the safe and reliable monitoring of the vehicle's braking system and thereby improving the safety of the vehicle during driving.

This application claims priority under 35 U.S.C. § 119 to application no. CN 2024 1144 0756.8, filed on Oct. 15, 2024 in China, the disclosure of which is incorporated herein by reference in its entirety.

The present application relates to a vehicle braking system, and more particularly to a method and apparatus for monitoring brake disc temperature by indirect measurement using a temperature sensor.

### BACKGROUND

A brake disc is an important part of a vehicle's braking system. Regularly checking the condition of the brake disc can ensure the reliability and effectiveness of the braking system and avoid any traffic accidents caused by the failure of the brake. However, the intuitive braking performance and wear resistance of the brake disc are usually difficult to test. Therefore, people will test the temperature of the brake disc after continuous braking, judge whether the braking characteristics of the brake disc have declined as well as the wear of the brake disc based on this, and then quantify the service life and safety of the brake disc. As for the temperature detection process of the brake disc, in the simulated control of a laboratory vehicle, the brake disc can be directly measured to obtain a certain temperature curve of the brake disc. However, this is not feasible for mass-produced vehicles because the temperature sensor cannot be directly mounted on or rest against the brake disc and therefore cannot directly obtain the actual temperature of the brake discs in the vehicle driving process. Thus, contactless measurement is necessary.

In contactless brake disc temperature measurement, infrared thermal imagers are often used to remotely detect the temperature of the brake disc, but their detection accuracy is limited in many aspects and is not sufficient.

When attempting to use high-precision wear-resistant thermocouple sensors to measure brake disc temperature, people have tried to use indirect methods to obtain the brake disc temperature. For example, using the brake hydraulic pressure or brake current applied to the brake disc and using simulation algorithms to obtain the estimated brake disc temperature. However, due to the low correlation between brake pressure or brake current and temperature, unacceptable errors are still present. In addition, although placing the temperature sensor close to but not in contact with the brake disc solves the problems that may be caused by the temperature sensor being in contact with the brake disc, during such a measurement process, it is necessary on the one hand to combine the three heat dissipation models of heat conduction, heat convection, and heat radiation to generate software for calculating brake disc temperature. However, in the end, the temperature difference from the actual temperature of the brake disc is over 100° C. For the temperature friction coefficient curve of 100° C., the assessment of u can differ by as much as a factor of two.

Accordingly, there is a need for a method and apparatus capable of relatively accurately and safely monitoring the temperature of a brake disc in a vehicle's braking system.

### SUMMARY

It is an aim of this application to provide a method and apparatus capable of relatively accurately and safely monitoring the brake disc temperature in a vehicle's braking system with an indirect temperature sensor. Specifically, a Kalman filter is used to optimally estimate the brake disc temperature using an indirect brake disc temperature sensor.

To achieve the above objective, the present application provides a vehicle brake disc temperature monitoring unit, comprising: a temperature collection module, which collects temperature values near the brake disc that change over time during vehicle braking; a temperature estimation module, which uses an observation model and a state estimation model to estimate the temperature of the brake disc based on the temperature values collected by the temperature collection module and the estimated values of the actual temperature of the brake disc through the Kalman filtering process; and a control module, which adjusts and controls the braking state of the vehicle braking system through the estimated temperature values and the detection values of the temperature sensor.

Optionally, the state estimation model of the estimation module comprises the following equation:

$${x}_{k} = {Ax}_{k - 1} + {Bu}_{k - 1} + {w}_{k}$$

Wherein, xₖ represents the calculated value obtained from the previous calculation value, A is the state transfer factor or function, which indicates how to infer the state at the current moment from the state at the previous moment, B is the control factor, which indicates how the control quantity u acts on the current state, and the control quantity u is the change of temperature over time or the temperature input value, and wₖ is the state estimation error with a normal distribution.

Optionally, the observational model of the estimation module comprises the following equation:

$${z}_{k} = {Hx}_{k} + {v}_{k}$$

Wherein, vₖ is the observation noise, zₖ is the observation value, H is the observation factor, and is a function or parameter, which represents a parameter related to the measurement accuracy of the temperature sensor itself.

Optionally, the estimation module comprises the following prediction update iterative equation:

$${\hat{x}}_{k} = {\hat{x}}_{k}^{-} + K ( {z}_{k} - H {\hat{x}}_{k}^{-} )$$

Wherein,

$$( {z}_{k} - H {\hat{x}}_{k}^{-} )$$

is the residual between the actual observation value and the expected observation value and K is the Kalman coefficient or gain.

Optionally, the state transfer factor or function takes into account the following factors: vehicle driving position, road conditions, ambient temperature, etc.

Optionally, the control factor takes into account the following factors: the gap between the temperature sensor and the brake disc surface and the heat transfer loss between the brake disc and the temperature sensor.

The present application further relates to a vehicle brake disc temperature monitoring system, comprising: a temperature sensor for detecting the temperature of a brake disc of a vehicle braking system; a sensor holder for holding the temperature sensor, the sensor holder holding the temperature sensor at a certain gap from the surface of the brake disc; and the vehicle brake disc temperature monitoring unit described above, which estimates an optimal estimated value closest to the actual brake disc temperature value based on the temperature observation value detected by the temperature sensor and the estimated value of the actual brake disc temperature.

Wherein, the temperature sensor has a gap from the surface of the brake disc that is less than a predetermined value.

The vehicle brake disc temperature monitoring system further comprises an information indicating apparatus which sends an alert to the vehicle control unit when the brake disc temperature exceeds a predetermined value, indicating that a problem may occur with the brake disc.

The present application further relates to a method for monitoring the temperature of a brake disc of a vehicle, the method being performed by a vehicle brake disc temperature monitoring unit as described above and the method comprising the following steps: providing a temperature sensor for detecting the temperature of the brake disc and arranging the temperature sensor close to the surface of the brake disc and with a certain gap between the temperature sensor and the surface of the brake disc; collecting the temperature value near the brake disc using the temperature sensor through the temperature collection module as the input value in the observation model; and estimating the estimated value iterated at each moment based on the observation value and the estimated value of the brake disc temperature through the estimation module and performing Kalman filtering on the estimated value and the observation value to obtain the optimal temperature estimation value.

By adopting the solution of the present application as described above, it is possible to use a temperature sensor that is not in contact with the brake disc and utilizes the Kalman filtering method to effectively estimate the temperature of the brake disc when it is impossible to directly measure the temperature of the brake disc using a temperature sensor installed on or abutting the brake disc, improving monitoring accuracy and allowing the safe and reliable monitoring of the vehicle's braking system and thereby improving the safety of the vehicle during driving.

### BRIEF DESCRIPTION OF THE DRAWINGS

The examples of the present application will be described in more detail with reference to the accompanying drawings, in which:

FIG. 1 schematically shows a schematic diagram of a monitoring unit of a brake disc with an indirect temperature sensor according to the present application;

FIG. 2 is a schematic diagram of a temperature sensor used in a monitoring unit according to the present application;

FIG. 3A shows a state in which the temperature sensor is arranged close to the brake disc for a test vehicle; FIG. 3B shows a state in which the temperature sensor is a certain distance from the brake disc;

FIG. 4 is a comparison diagram of temperature value curves measured by the temperature sensor in the states shown in FIG. 3A and FIG. 3B, respectively, during the vehicle braking process;

FIG. 5 is a schematic calculation block diagram of a temperature estimation module of a brake disc temperature monitoring unit according to the present application;

FIG. 6 is a schematic diagram of a temperature monitoring unit according to the present application.

### DETAILED DESCRIPTION

Preferred examples of the present application are described in detail below in conjunction with the examples. It will be understood by those skilled in the art that these examples are not intended to limit the present application in any way and the features in each example may be combined with each other. The same components are indicated by the same reference numerals in different figures, and certain components are omitted for simplicity, but this does not mean that other components are excluded. It should be understood that the dimensions, proportional relationships, and number of components shown in the drawings are not to be considered as limitations on the present application.

As previously mentioned, direct detection of brake disc temperature using high-precision, wear-resistant thermocouple temperature sensors in test vehicles cannot be applied to mass-produced vehicles. In order to test high temperatures on a rotating object, when measuring the temperature of a brake disc, since the exact temperature value on the brake disc cannot be directly obtained, indirect monitoring methods are considered. For example, infrared thermal imagers are mainly used to detect whether the friction material of the brake disc is appropriate. If the brake disc temperature as detected by an infrared thermal imager rises sharply after continuous braking, it may indicate that the friction material of the brake disc is too soft, which will reduce braking performance. If the temperature change trend is slow, it means that the friction material is too hard, which may cause the brake disc to wear faster. At the same time, problems may occur during emergency braking, resulting in brake failure. However, infrared thermal imagers still have large measurement errors. In addition, there is also a method of calculating brake disc temperature through software simulation, which combines the three heat dissipation models of heat conduction, heat convection, and heat radiation to generate software for calculating brake disc temperature. However, such calculations often result in temperature differences of up to 100° C. For the temperature friction coefficient curve of 100° C., the assessment of u can differ by as much as a factor of two, which results in an inability to accurately obtain information on the brake disc temperature and may cause the brake disc to be damaged due to high temperature, leading to brake failure.

In view of this, the present application intends to use a combination of software and hardware, i.e., an indirect temperature sensor and an optimal iterative estimation method for observation values, to relatively accurately monitor brake disc temperature.

In general, the method of detecting and estimating brake disc temperature in an indirect way adopts Kalman filtering, which obtains the temperature estimation-related data of the brake disc at the current moment, including the current temperature of the brake disc, vehicle speed, wheel speed, current ambient temperature, and brake pressure when the vehicle brakes. This data is input into a pre-built brake disc temperature estimation model, which is obtained by calibrating preset heating model coefficients and heat dissipation model coefficients. This method realizes the real-time estimation and prediction of the vehicle's brake disc temperature at the next moment with high accuracy, helping the driver to grasp brake disc temperature at the next moment in time and ensuring driving safety.

Therefore, in the present application, a temperature sensor comprising, e.g., a thermocouple or a thermistor is used and fixed at a certain distance from the brake disc. The heat source temperature is mainly detected by thermal radiation, and then the Kalman filtering algorithm is used to compensate for the direct detection error. The temperature compensation requirements of the brake disc are met by combining software and hardware, and the optimal estimated temperature closest to the actual temperature of the brake disc can be obtained as accurately as possible.

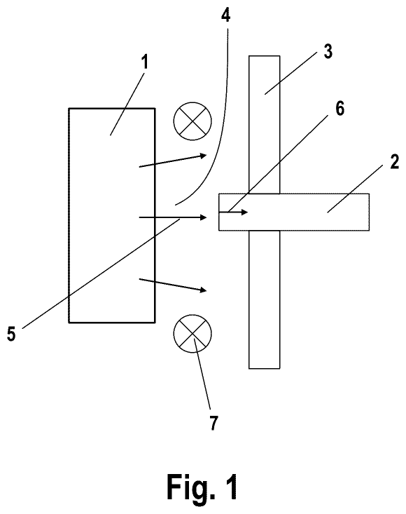

A schematic diagram of a state in which a temperature monitoring unit according to the present application is mounted to a brake disc of a vehicle braking system is shown in FIG. 1. As shown in the figure, the vehicle braking system comprises brake discs 1 located on both sides, and the monitoring unit further comprises a temperature sensor 2 installed close to the brake discs 1 and a holder 3 for holding the temperature sensor 2. The temperature sensor 2 is installed to be spaced apart from the surfaces of the brake discs 1 by a gap 4. The gap 4 cannot be too large or the temperature sensing by the temperature sensor 2 will be distorted too much, thereby losing the purpose of using the observation value as a reference for estimation. The gap 4 also cannot be too small or the placement of the sensor 1 will affect the brake discs 2 as the wheel (not shown) rotates or the temperature sensor 1 wears. That is, the temperature sensor 2 must always be kept as close to the brake discs 1 as possible but not in contact with the brake discs 1.

While the holder 3 is shown in the figure as a separate component, modifications may also be made as desired. For example, the brake discs 1 have a heat shield and the temperature sensor 2 can be directly mounted on the heat shield of the brake discs 1, e.g., by being fixed to the heat shield by threaded connection or welding. In this case, the heat shield of the brake discs 1 itself constitutes the holder for the temperature sensor 2.

FIG. 1 also shows heat transfer from the brake discs 1 to the temperature sensor 2 during braking. For example, arrow 5 shows the process of heat transfer by radiation, arrow 6 shows the process of heat transfer by conduction, and arrow 7 shows the process of heat transfer by convection.

The relevant equations for heat transfer are expressed as follows:

$$Q = e σ A ( {T}_{surface}^{4} - {T}_{ambient}^{4} )$$

$$Q = hA ( {T}_{surface} - {T}_{fluid} )$$

$$Q = \frac{kA ( {T}_{hot} - {T}_{cold} )}{d}$$

These heat transfer processes will be taken into account in the deviation or covariance of the temperature values measured by the temperature sensor 2

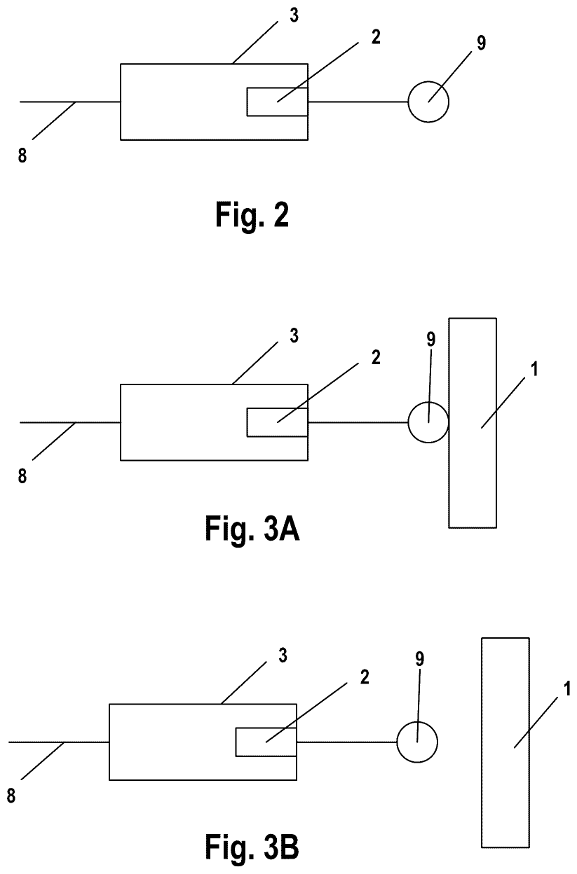

FIG. 2 schematically shows a schematic external view of a temperature sensor 2 and a holder 3, wherein the temperature sensor 2 may be built into the head of the holder 3, the temperature sensor 2 having a probe 9 for sensing the temperature. The holder 3 also has a data line 8 that transmits sensor data to an estimation unit (not shown in the figure). The data line 8 may also be set to communicate with the estimation unit via a wireless connection to accurately iterate the measured temperature data.

FIGS. 3A and 3B respectively show the position and state diagrams when the temperature sensor 2 is used to detect the temperature on the brake disc of a laboratory vehicle. In FIG. 3A, the probe 9 of the temperature sensor 2 is against the brake discs 1, while in FIG. 3B, the probe 9 of the temperature sensor 2 is separated from the brake discs 1 by a gap.

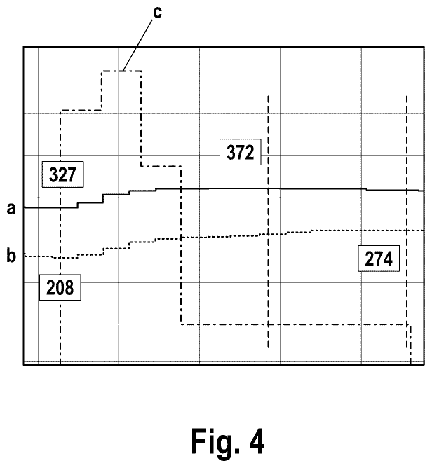

FIG. 4 shows a graph showing the relationship between the actual temperature value measured during real-time temperature detection on the brake discs of a laboratory vehicle during braking (FIG. 3A) and the indirect temperature value measured using the indirect temperature sensor in FIG. 3B.

As can be seen from FIG. 4, during the braking process of the brake discs 1, the value measured by the temperature sensor when the probe 9 of the temperature sensor 2 is close to the surface of the brake discs 2 is called the reference value, which is represented by curve a in the figure, and the temperature value measured by the temperature sensor 2 when the probe 9 of the temperature sensor 2 is arranged at a certain gap from the brake discs is called the indirect temperature value, which is represented by curve b in the figure. It can be seen that curve a and curve b basically follow the same change trend, and at the same time, the reference values and indirect temperature values of curve a and curve b differ by more than 100°, which can be set as the deviation estimate value when optimizing the evaluation of the indirect temperature value.

In the present application, a Kalman filtering process is introduced based on the reference value and the observation value of the indirect temperature to perform optimization autoregressive data processing so as to estimate the optimal estimated value closest to the actual temperature value of the brake disc surface based on the indirect temperature value, thereby improving the estimation accuracy of the contactless indirect temperature detection process of the brake discs.

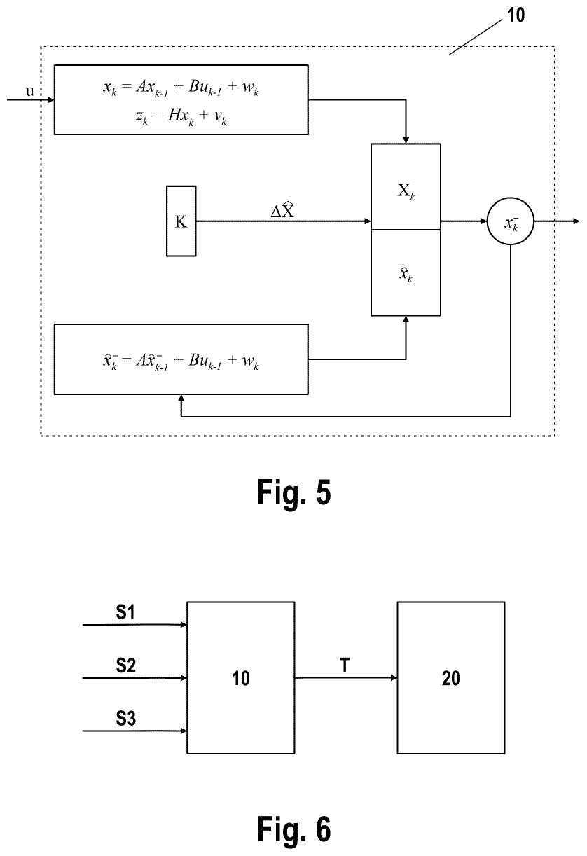

The brake disc temperature monitoring unit of the present application includes an estimation module 10 as shown in FIG. 5. The estimation module 10 constructs a physical model for the process of detecting the temperature of the brake disc.

The linear model equation of the estimation module 10 is as follows:

$${x}_{k} = A {x}_{k - 1} + B {u}_{k - 1} + {w}_{k}$$

Wherein, xₖ represents the calculated value obtained from the previous calculation value, A is the state transfer factor or function, which indicates how to infer the state at the current moment from the state at the previous moment, B is the control factor, which indicates how the control quantity u acts on the current state, and the control quantity u can be the change of temperature over time or the temperature input value. wₖ is the state estimation error with a normal distribution, e.g., the factors affecting the temperature value caused by heat loss caused by the heat conduction, heat convection, and heat radiation mentioned above.

The estimation module 10 also establishes an observation model equation as follows:

$${z}_{k} = {Hx}_{k} + {v}_{k}$$

Wherein, xₖ is the observation noise, zₖ is the observation value, H is the observation factor, and may be a function or parameter, which represents a parameter related to the measurement accuracy of the temperature sensor itself, such as measurement error, ambient temperature, and other related parameters. For example, the gap between the temperature sensor 2 and the brake discs 1 etc. are all factors that can be considered.

The optimization autoregressive process based on the above model equation includes a state prediction step, which predicts the state and state covariance at the current moment based on the dynamic model of the system and the state estimate at the previous moment.

The state prediction equation is as follows:

$${\hat{x}}_{k}^{-} = {Ax}_{k - 1}^{-} + {Bu}_{k - 1} + {w}_{k}$$

Wherein, the chamfered tip of \hat{x}ₖ⁻ represents the estimate of x, the superscript “−” indicates that this value is calculated based on the previous value, and Wk is a normally distributed state error.

This is followed by an update step, where the Kalman gain is calculated based on the observed data and the predicted state, and the state estimate and state covariance are updated.

During the iterative process of estimating the brake disc temperature value, the following iterative update equation is used:

$${\hat{x}}_{k} = {\hat{x}}_{k}^{-} + K ( {z}_{k} - H {\hat{x}}_{k}^{-} )$$

Where

$$( {z}_{k} - H {\hat{x}}_{k}^{-} )$$

is the residual between the actual observation value and the expected observation value and K is the Kalman coefficient or gain.

As previously mentioned, in addition to the accuracy range of the temperature sensor itself used to detect the observation value, the covariance of the value of % is included in the Kalman filtering formula for calculation. In addition, when using the Kalman filter to predict temperature and establish a dynamic temperature model, it is necessary to consider it based on the actual vehicle. Therefore, the surrounding heat capacity, heat source, thermal resistance, etc. can also be considered.

For example: the effect of the entire thermal circuit consisting of heat capacitance, heat source, and thermal resistance on the heat at the temperature sensor.

In addition, while the present application uses a temperature sensor to measure close to the brake discs, the degree of closeness is limited by many factors, such as vehicle vibration, brake disc wear, etc. Therefore, the gap between the brake disc surface and the temperature sensor is not fixed. This gap can also be considered as a parameter. For example, the final degree of brake disc wear can be determined based on the change in the gap, thereby judging the amount of brake disc wear, and then the amount of brake disc wear can be directly used to judge whether the brake disc is still within the safe use range, or the gap can be associated with the temperature of the brake discs.

In the present application, a temperature sensor is selected that is close enough to the brake disc to obtain greater heat radiation power. For example, the gap 4 between the temperature sensor shown in FIG. 1 and the brake discs may be maintained within a predetermined value, such as within 5 mm, e.g., 4-5 mm, or within 1 mm, to obtain more accurate and effective data. Of course, the above-mentioned values for the gap 4 are merely exemplary and may be adjusted as necessary, and different noise covariances can be used for estimation of this gap.

The estimation module 10 of the brake disc temperature monitoring unit is shown in detail in FIG. 5, in which the indirect temperature value detected by the brake disc temperature sensor 2 and the estimated value from the estimation unit are optimized and evaluated based on the state estimation equation, the observation equation, and the Kalman gain coefficient so as to obtain the optimal estimated value closest to the actual value of the brake disc temperature.

That is, in the estimation module 10, the optimal estimated value is obtained by combining the observation model and the prediction model with the Kalman filtering parameters.

FIG. 6 shows a schematic block diagram of a brake disc temperature monitoring unit in accordance with the examples of the present application, wherein the parameter information S1 is input into the estimation module 10 as previously described, such as the temperature value of the brake discs detected by the brake disc temperature sensor 2, or temperature changes over time, or other temperature control parameters of the brake discs, such as brake pressure, brake disc wear, etc. The output information of the estimation module 10 is the estimated optimal brake disc temperature information T, which is the value closest to the possible actual brake disc temperature. The temperature information T is then collected by the control module 20 in order to output and monitor the temperature of the brake discs in real time. The braking state of the vehicle braking system is adjusted and controlled by the estimated temperature value and the detection value of the temperature sensor in order to identify whether the working state of the brake discs is abnormal and promptly issue an alert to the vehicle driver.

The estimation module 10 may also receive other optional information as random input parameters, such as positioning information of the vehicle, vehicle driving status and road surface information, and environmental parameter information, which may have a large impact on the detection error of the temperature sensor.

In the present application, the advantages of combining a temperature sensor composed of a thermocouple or thermistor with a Kalman filter are: the sensor will not wear out due to contact with the brake disc, saving costs. On the other hand, software and hardware are used to calibrate the actual target temperature, which improves the accuracy of temperature detection. In addition, the standard life of the vehicle can be taken into account in the selection of temperature sensors, e.g., 15 years/300,000 kilometers, improving the service life of the sensors.

Although the present disclosure has been described with respect to preferred embodiments, this is not meant to limit the present disclosure. It should be understood that the scope of protection of the present disclosure is defined by the appended claims, and various modifications may be made by those skilled in the art without departing from the scope.

What is claimed is:

1. A vehicle brake disc temperature monitoring unit, comprising:
a temperature collection module configured to collect temperature values near a brake disc that change over time during vehicle braking;
a temperature estimation module configured to use an observation model and a state estimation model to estimate temperature of the brake disc based on the temperature values collected by the temperature collection module and estimated values of actual temperature of the brake disc through a Kalman filtering process; and
a control module configured to adjust and control a braking state of a vehicle braking system through the estimated temperature values and the detection values of the temperature sensor.

2. The vehicle brake disc temperature monitoring unit according to claim 1, wherein the state estimation model of the temperature estimation module comprises the following equation:
$${x}_{k} = {Ax}_{k - 1} + {Bu}_{k - 1} + {w}_{k} , and$$
wherein, xₖ represents a calculated value obtained from a previous calculation value, A is a state transfer factor or function, which indicates how to infer a state at the current moment from a state at the previous moment, B is a control factor, which indicates how a control quantity u acts on the current state, and the control quantity u is a change of temperature over time or a temperature input value, and wₖ is a state estimation error with a normal distribution.

3. The vehicle brake disc temperature monitoring unit according to claim 1, wherein the observation model of the temperature estimation module comprises the following equation:
$${z}_{k} = {Hx}_{k} + {v}_{k} ,$$
and
wherein, vₖ is an observation noise, zₖ is an observation value, H is an observation factor, and is a function or parameter, which represents a parameter related to measurement accuracy of the temperature sensor itself.

4. The vehicle brake disc temperature monitoring unit according to claim 1, wherein the temperature estimation module comprises the following prediction update iterative equation:
$${\hat{x}}_{k} = {\hat{x}}_{k}^{-} + K ( {z}_{k} - H {\hat{x}}_{k}^{-} ) ,$$
and
wherein,
$$( {z}_{k} - H {\hat{x}}_{k}^{-} )$$
is a residual between an actual observation value and an expected observation value and K is a Kalman coefficient or gain.

5. The vehicle brake disc temperature monitoring unit according to claim 2, wherein the state transfer factor or function takes into account the following factors: vehicle driving position, road conditions, and/or ambient temperature.

6. The vehicle brake disc temperature monitoring unit according to claim 2, wherein the control factor takes into account the following factors: the gap between the temperature sensor and the brake disc surface and heat transfer loss between the brake disc and the temperature sensor.

7. A vehicle brake disc temperature monitoring system, comprising:
a temperature sensor configured to detect temperature of a brake disc of a vehicle braking system;
a sensor holder configured to hold the temperature sensor, the sensor holder being configured to hold the temperature sensor at a certain gap from a surface of the brake disc; and
the vehicle brake disc temperature monitoring unit according to claim 1.

8. The vehicle brake disc temperature monitoring system according to claim 7, wherein the temperature sensor has a gap from the surface of the brake disc that is less than a predetermined value.

9. The vehicle brake disc temperature monitoring system according to claim 7, further comprising an information indicating apparatus which is configured to send an alert to a vehicle control unit when the brake disc temperature exceeds a predetermined value, indicating that a problem may occur with the brake disc.

10. A method for monitoring temperature of a brake disc of a vehicle, the method being performed by the vehicle brake disc temperature monitoring unit according to claim 1, and the method comprising:
providing a temperature sensor that is configured to detect the temperature of the brake disc and arranging the temperature sensor close to the surface of the brake disc and with a certain gap between the temperature sensor and the surface of the brake disc;
collecting the temperature value near the brake disc using the temperature sensor through the temperature collection module as the input value in the observation model; and
estimating the estimated value iterated at each moment based on the observation value and the estimated value of the brake disc temperature through the estimation module and performing Kalman filtering on the estimated value and the observation value to obtain the optimal temperature estimation value.

11. The vehicle brake disc temperature monitoring system according to claim 7, wherein the vehicle brake disc temperature monitoring unit is configured to estimate an optimal estimated value closest to the actual brake disc temperature value based on the temperature observation value detected by the temperature sensor and the estimated value of the actual brake disc temperature.
